(19) United States
(12) Patent Application Publication
(10) Pub. No.: US 2002/0153000 A1
(43) Pub. Date: Oct. 24, 2002

(54) Surface restoration and maintenance composition and method of restoring a surface

(76) Inventors: Brian T. Holland, Chicago, IL (US); Pablo M. Hernandez, Waukegan, IL (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 10/073,808

(22) Filed: Feb. 11, 2002

Related U.S. Application Data
(60) Provisional application No. 60/270,044, filed on Feb. 20, 2001.

(51) Int. Cl. B28D 1/00

(52) U.S. Cl. 125/30.01; 125/1

(57) ABSTRACT

The present invention is directed to a surface restoration composition including an organic acid, a metal oxide and a plasticizer. Optionally, dispersants, thickeners and water can be included in the composition. The inventive composition is applied to a stone surface and buffed to dryness to achieve the desired level of gloss.

### CROSS-REFERENCE TO RELATED APPLICATIONS

THIS APPLICATION CLAIMS PRIORITY OF U.S. PROVISIONAL PATENT APPLICATION NO. 60/270,044, FILED Feb. 20, 2001.

### STATEMENT REGARDING FEDERALLY SPONSORED RESEARCH OR DEVELOPMENT

NONE

1. Background of the Invention

This invention relates generally to a composition for restoring a surface and in particular a stone surface. More particularly it relates to such a composition which reduces the need for removal of layers of the stone surface and production of a high gloss finish.

2. Background of the Art

Marble is a natural stone that is relatively soft, therefore resulting in scratching and other surface damage which requires a high degree of maintenance. Additionally, marble and other stone surfaces are often reactive to components found in common cleaners and polishes. For these reasons considerable care must be taken in order to maintain a healthy looking surface. Other types of stone flooring including terrazzo, magnesite, limestone, granite and travertine also need to be maintained at a high level to reduce or remove scratches.

Waxes and finishes have been used as coatings for stone surfaces to increase the gloss and maintain the appearance of the surfaces, however, these types of products do not last long as adhesion to the stone surface is a problem and the resulting appearance gives a more plastic-like look which is undesirable.

Additionally, for years, organic acids such as oxalic acid have been used to “recrystallize” stone type surfaces, in particular, floors. One drawback in using such a process is the lengthy application time and subsequent cumbersome cleanup. For example, typical application of oxalic acid or oxalic acid based products requires about 5 to 15 minutes per 20 to 25 square feet. Such compositions can be applied as a powder or slurry along with copious amounts of water with buffing. The composition is not allowed to dry, as significant, undesirable streaking will occur. The subsequent cleanup involves moving the product to the next section of the flooring or mopping up all the residue. Additionally, during application, the composition must continually be removed to determine the level of gloss achieved. Lack of control in the process as well as labor intensive, messy application and cleanup, are significant problems encountered when using such prior art compositions.

Additionally, such compositions depend on utilization of minerals in the surface itself to be effective, thereby resulting in the removal of some portion of the surface itself. Examples of such oxalic acid containing compositions can be found in U.S. Pat. Nos. 90,754; 133,095; 145,971; 181,790; 370,551; 542,524; 1,574,406; 3,481,879; and 4,297,148.

Silicofluorides, and in particular magnesium silicofluoride, have also been used to “recrystallize” the surfaces of marble and other stone floorings without much success. Such compositions are less efficient than those containing oxalic acid in restoring gloss and repairing damage. In particular, these compositions typically etch the surface causing considerable damage. Examples of such compositions can be found in U.S. Pat. Nos. 5,830,536; 4,738,876; and 4,756,766.

Additionally, oftentimes both oxalic acid and silicofluorides are used to treat stone surfaces for example, U.S. Pat. No. 5,490,883 discusses a stone floor composition containing oxalic acid and silicofluorides. However, such products suffer from the same shortcomings as silicofluorides and oxalic acid based compositions themselves, in that etching of the surface and mess, lengthy application time and lack of control are major drawbacks.

Further, metal oxides are sometimes added as abrasives to add additional polishing to such compositions, however many skilled in the art believe such polishing effect is of little or no consequence.

In summary, a considerable number of deficiencies exist in the art relating to stone surface restoration compositions and methods of application. While prior art oxalic acid containing compositions provide some gloss and restoration, the labor intensive and time consuming application methods and cleanup of such compositions make them less than desirable, expensive and time consuming. Additionally, the gloss that is achieved is not easily controlled. Further, coating of stone surfaces with waxes and floor finishes, while providing an increased gloss and maintaining the appearance of floors results in difficulties with long lasting adhesion and a plastic-like, unattractive appearance. Further, many compositions tend to etch the surface and cause considerable damage. Additionally, such compositions are messy and time consuming to apply.

Thus, there is an ongoing search for restoration and maintenance compositions which can be spread easily, provide the desired high gloss and restoration of scratches and gouges on stone surfaces while maintaining an acceptable method of application which reduces man hours and mess and provides a degree of control to gloss achievement. Clearly, there is a need for improved and novel stone surface restoration and maintenance compositions that provide high gloss while reducing labor intensive application methods and stand up to repeated high traffic and abuse. In particular, there is a need for improved restoration compositions, which overcome the shortcomings of the compositions of the prior art.

### OBJECTS OF INVENTION

It is an object of this invention to provide a surface restoration and maintenance composition which overcomes some of the problems and shortcomings of the prior art. A further object of the invention is to provide a restoration composition that can be used on stone surfaces in an efficient manner. Another object of this invention is to provide a restoration composition which produces the desired high gloss as well as exhibits improved durability on stone surfaces. Another object of the invention is to provide a high gloss durable finish to stone surfaces in a reasonably controlled manner. These and other important objects will be apparent from the following description and from the drawings.

### SUMMARY OF THE INVENTION

The present invention is directed to a surface restoration composition which includes an organic acid, a metal oxide; and a plasticizer. The composition may further include a dispersant. Additionally, a thickener can be included in the composition. The composition can optionally include water. Typical compositions include about 1 to 50 weight percent organic acid, about 1 to 50 weight percent metal oxide and about 0 to 5 percent plasticizer.

The organic acid can be oxalic acid, glyoxylic acid, maleic acid, salicylic acid, tartaric acid, acetic acid and blends thereof Preferably, the organic acid is oxalic acid. The metal oxides found to be useful in the present invention include aluminum oxide, titanium oxide, zinc oxide, tin oxide, silicon dioxide, zirconium oxide, manganese oxide and magnesium oxide, and combinations thereof. Typically, the metal oxide is in particulate form and has a particle size of about 1 nanometer to about 100,000 nanometers, with preferred embodiments utilizing a metal oxide having a particle size of about 10 nanometer to about 100 nanometers.

The inventive compositions also include a plasticizer. Useful plasticizers can include primary and secondary alcohols, primary (saturated and unsaturated) secondary, tertiary and aromatic carboxylic acids, benzoate derivatives, phosphate derivatives and blends thereof.

Such compositions have been found to be useful in the restoration and maintenance of a stone surface to a high gloss finish in a non-abrasive manner.

The inventive compositions are applied to a surface to be restored or maintained by applying the composition to the surface by pouring, spraying, sprinkling, rolling, etc. and buffing the composition to dryness.

### BRIEF DESCRIPTION OF THE DRAWINGS

FIG. 1 is a cross-sectional view illustrating a damaged stone surface.

FIG. 2 is a cross-sectional view illustrating a composition of the present invention which has repaired the damage to a stone surface.

### DETAILED DESCRIPTION OF THE PREFERRED EMBODIMENTS

The present invention is directed to an improvement in compositions for treating stone surfaces—namely, compositions for restoration and maintenance of stone surfaces and methods of restoring such stone surfaces. The surface restoration compositions of the present invention include organic acid, metal oxide and plasticizer, as described in further detail below.

Organic acids such as oxalic acid, glyoxylic acid, maleic acid, salicylic acid, tartaric acid, acetic acid and blends thereof along with other types of acids have been found to be particularly useful in the present invention. In particular, oxalic acid has been found to produce acceptable results when used in the present compositions. The inventive composition typically includes about 1 to 85 weight percent of an organic acid. Preferred embodiments include about 5 to 60 weight percent of an organic acid.

The metal oxide of the present invention acts as a filler for the damaged surface, a network stabilizer or binder and a gloss enhancer. Metal oxides of the type including aluminum oxide, titanium oxide, zinc oxide, tin oxide, silicon dioxide, zirconium oxide, manganese oxide and magnesium oxide, and combinations thereof can be utilized in the inventive compositions. Preferably, the inventive combinations include about 1 to 50 weight percent metal oxide. Preferred embodiments include about 1 to 25 weight percent metal oxide.

It is particularly useful to utilize metal oxide in particulate form. Such metal oxide particles should be of the size of about 1 nanometer to about 100,000 nanometers with preferred embodiments utilizing particles of the size 10 to 10,000 nanometers. Highly preferred embodiments make use of metal oxide particles in the range of about 10 to 100 nanometers.

The plasticizers of the present invention are utilized to reduce the capillary pressure and thus limit the amount of cracking as the inventive composition dries on a surface and to increase workability, thereby, resulting in less streaking and improved uniformity in overall gloss. A variety of plasticizers can be used and include primary and secondary alcohols, for example propanol and glycerol, primary (saturated and unsaturated) secondary, tertiary and aromatic carboxylic acids, for example capric acid, oleic acid, 2-methylhexanoic acid, neo decanoic acid and benzoic acid, benzoate derivatives, for example, isodecyl benzoate, phosphate derivatives such as tributoxyethyl phosphate and blends thereof. The inventive compositions preferably include about 0 to 10 weight percent of a plasticizer. Preferred embodiments include about 0.25 weight percent to about 2.0 weight percent plasticizer.

The inventive compositions can also optionally include a dispersant. A dispersant is a substance that promotes the formation and stabilization of one substance in another. The dispersant can be included in the present invention to minimize the formation of crystals larger than 100 Â by the calcium oxalate. It is believed that dispersant acts to stabilize smaller crystals by neutralizing the high charge/volume ratio, thereby preventing the formation of large crystals.

Calcium carbonate is the main component of marble along with other metal oxides and/or metal salt impurities whereas granite is mainly composed of silicon dioxide. It is believed that when the inventive composition is applied to a stone surface, and worked into the surface, the acid reacts with calcium carbonate to form calcium oxalate, which fills the voids between the larger particles of calcium carbonate crystals with a vitreous (amorphous, glass-like) layer of calcium oxalate. Large crystals increase the scattering of light and result in lower gloss and a dimpled effect. If a dispersant is added, the surface becomes stabilized as the positively charged species interact lessening the chance of large particle formulation. Dispersants useful in the present compositions are widely known by those of ordinary skill in the art and can include polyacrylic acids and polyphosphonates. One such dispersant, ACUSOL 425N is a polyacrylic acid available from Rhom and Haas. The present inventive composition may include about 0.10 weight percent to about 10 weight percent of a dispersant. Highly preferred embodiments include about 0.25 weight percent to about 2.0 weight percent dispersant.

Additionally, a thickener such as xanthum gum can be added to the compositions of the present invention to suspend the metal oxide particles. Preferred thickeners are available from Kelco under the name KELZAN. Typical ranges of thickener are about 0.25 weight percent to about 2.0 weight percent of the composition. The compositions can also include water.

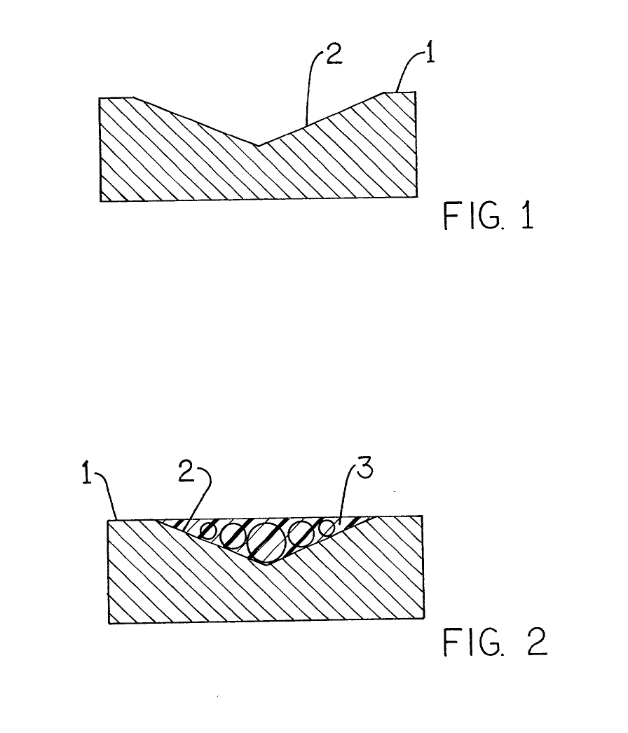

FIG. 1 is illustrative of a damaged stone surface 1. The surface 1 includes a gouge or scratch 2. As can be seen in FIG. 2, when the inventive composition 3 is applied to the surface 1 the composition 3 deposits crystal particles into the scratch 2, thereby resulting in a vitreous high gloss surface.

It has been found useful to utilize a new method of applying the present compositions to a stone surface. Unlike prior application methods, the compositions of the present invention are applied to a stone surface without the introduction of additional water. Only if the inventive compositions are applied in dry form is the addition of water required. The composition is then spread over the surface and buffed to dryness. This process can be repeated if necessary to achieve a desired level of gloss. The compositions of the present invention can be applied to a surface in a number of ways including, pouring, spraying, sprinkling, rolling, etc.

Example 1 represents a composition of the present invention.

EXAMPLE 1

| Ingredients | Percent by Weight |
|---|---|
| Water | 76.75 |
| ACUSOL 425N | 0.25 |
| Oxalic Acid | 16.00 |
| Aluminum Oxide | 7.00 |

The composition of Example 1 is prepared by adding ACUSOL 425N to water with high speed mixing. Oxalic acid is then added and stirred at high speeds to form a uniform milky substance. The aluminum oxide is added and stirred at high speed until dispersed.

Table 1 represents results and comparison testing on a marble floor surface which was initially stripped of any floor finish with a Johnson Wax Professional floor finish stripper FREEDOM at a 1 to 4 dilution ratio. The surface was then honed with 400 grit diamond polishing stone to make it as uniform as possible before testing with various compositions. Two different modes of the application were used for run one and run two using the composition of Example 1.

Run one utilized an application technique typical in the industry. Approximately 2 ounces of the composition was applied to the floor with additional water and then worked in with a disposable carpet bonnet for 5 minutes. The composition was then removed with a mop and bucket.

Run two involved utilization of a new application technique. The composition was applied to the floor surface with no additional water added and was buffed to dryness with a disposable carpet bonnet. Buffing to dryness took approximately 3 minutes.

The “EC Marble Polishing Powder” of Run 3 is available from EastChem, Pte, Ltd, Singapore contains oxalic acid and tin oxide. As directed on the label, one ounce of the powder was applied along with 4 ounces of water. This material was buffed for 5 minutes and then removed with a mop and bucket.

A gloss meter, which measures reflectivity at 20° and 60°, was used to measure initial gloss and final gloss with higher numbers producing better gloss. Overall appearance was an evaluation based on uniformity, gloss and clarity of the treated surface.

TABLE 1

| | | Initial | Final | Floor | | Overall |
|---|---|---|---|---|---|---|
| Run | | Gloss | Gloss | Area | Buffing | Appearance |
| No. | Example | 20°/60° | 20°/60° | (ft²) | Time | (1 = best) |
| 1 | From Table I | 2/11 | 36/69 | 24 | 5 min | 4 |
| 2 | From Table I | 2/12 | 41/71 | 24 | 3 min | 1 |
| 3 | EC Marble | 2/11 | 54/68 | 24 | 10 min | 4 |
| | Polishing | | | | | |
| | Powder | | | | | |

As can be seen from Table 1, all of the compositions provided acceptable levels of gloss but overall visual appearance varied greatly. The inventive composition applied utilizing the new application technique of Run 2 outperformed all other compositions and application methods. Additionally, application times were considerably reduced. Further, cleanup of the inventive composition of Run 2 was very minimal with buffing to dryness.

Example 2 provides another composition of the present invention.

EXAMPLE 2

| Ingredients | Percent by Weight |
|---|---|
| Water | 76.25 |
| Tributoxyethyl | 0.50 |
| phosphate | |
| ACUSOL 425N | 0.25 |
| Oxalic Acid | 16.00 |
| Aluminum Oxide | 7.00 |

The composition of Example 2 was prepared by adding the ACUSOL 425N and the tributoxyethyl phosphate to the water with high speed mixing. The oxalic acid was then added and stirred at high speed to form a uniform milky substance. The aluminum oxide was then added and stirred at high speed until dispersed.

Table 2 shows the results from tests conducted on a beige marble floor surface of 25 ft² and a white marble floor surface of 25 ft² that was honed with 400 grit polishing stones before testing. Runs 1 and 3 were conducted by pouring 2 oz of the composition of Example 2 onto the surface and then buffing to dryness. Runs 2 and 4 were conducted by spraying on (ca. 0.5 oz) of the composition of Example 2 and then buffing to dryness.

TABLE 2

| | | Initial | Final | | |
|---|---|---|---|---|---|
| | | Gloss | Gloss | Floor Area | Buffing |
| Run No. | Example | 20°/60° | 20°/60° | (ft²) | Time |
| 1 (beige | From Table II | 5/26 | 65/92 | 25 | 3 min |
| tile) | (2 oz of product) | | | | |
| 2 (beige | From Table II | 65/92 | 84/98 | 25 | 1.5 min |
| tile) | (0.5 oz of product) | | | | |
| 3 (white | From Table II | 4/16 | 72/92 | 25 | 3 min |
| tile) | (2 oz of product) | | | | |
| 4 (white | From Table II | 72/92 | 77/97 | 25 | 1.5 min |
| tile) | (0.5 oz of product) | | | | |

The compositions of Example 2 exhibit significantly increased gloss readings from those of Example 1. The compositions required very minimal clean up as it is buffed to dryness in its application. It is also easy to see if additional application of the composition is needed to achieve the desired gloss since the composition is buffed to dryness rather than prior art processes which require the removal of a slurry to view the underlying surface and gloss level.

Example 3 provides yet another composition of the present invention.

EXAMPLE 3

| Ingredients | Percent by Weight |
|---|---|
| Water | 75.75 |
| KELZAN T | 0.5 |
| Tributoxyethyl phosphate | 0.50 |
| ACUSOL 425N | 0.25 |
| Oxalic Acid | 16.00 |
| Aluminum Oxide | 7.00 |

The composition of Example 3 is prepared by adding KELZAN T to water and stirring at high speed until dispersed. The remaining ingredients are added as in Example 2.

Example 4 provides yet another composition of the present invention.

EXAMPLE 4

| Ingredients | Percent by Weight |
|---|---|
| Water | 61.5 |
| Oxalic | 30.5 |
| Al₂O₃ | 7.00 |
| KELZAN ASX | 0.5 |
| KP.140 | 0.5 |
| | 100 |

The composition of Example 4 is prepared by adding KELZAN ASX to water and stirring at high speed until dispersed. The remaining ingredients are added as in Example 2.

Table 3 shows the results from tests conducted on a beige marble floor surface of 20 ft² that was honed with 400 grit polishing stones before testing. The inventive composition was compared to prior art compositions. Runs were conducted by pouring the composition of Example 4 onto the surface and then buffing to dryness.

TABLE 3

| | Floor Area | Initial Gloss | Final Gloss |
|---|---|---|---|
| Composition | (ft²⁾ | 20°/60° | 20°/60° |
| 0.5 oz Inventive Comp | 28 | 7.2/21.0 | 41/74 |
| Pasta Blanca 3.5 oz | 20 | 7.7/20.2 | 21/55 |
| Terranova | 20 | 12.4/29.1 | 17/46 |

These examples represent a few of the possible formulations of the inventive compositions. While the principles of this invention have been described in connection with specific embodiments, it should be understood clearly that these descriptions are made only by way of example and are not intended to limit the scope of the invention.

What is claimed is:

1. A surface restoration composition comprising:
an organic acid;
a metal oxide; and
a plasticizer.

2. The surface restoration composition of claim 1 further including a dispersant.

3. The surface restoration composition of claim 1 further comprising a thickener.

4. The surface restoration composition of claim 1 comprising:
about 1 to 50 weight percent organic acid;
about 1 to 50 weight percent metal oxide; and
about 0 to 5 percent plasticizer.

5. The surface restoration composition of claim 1 further comprising water.

6. The surface restoration composition of claim 1 wherein the organic acid is selected from the group consisting of oxalic acid, glyoxylic acid, maleic acid, salicylic acid, tartaric acid, acetic acid and blends thereof.

7. The surface restoration composition of claim 6 wherein the organic acid is oxalic acid.

8. The surface restoration composition of claim 1 wherein the metal oxide is selected from the group consisting of aluminum oxide, titanium oxide, zinc oxide, tin oxide, silicon dioxide, zirconium oxide, manganese oxide and magnesium oxide, and combinations thereof.

9. The surface restoration composition of claim 8 wherein the metal oxide is in particulate form and has a particle size of about 1 nanometer to about 100,000 nanometers.

10. The surface restoration composition of claim 9 wherein the metal oxide is in particulate form and has a particle size of about 10 nanometer to about 100 nanometers.

11. The surface restoration composition of claim 1 wherein the plasticizer is primary and secondary alcohols, primary (saturated and unsaturated) secondary, tertiary and aromatic carboxylic acids, benzoate derivatives, phosphate derivatives and blends thereof.

12. A surface restoration composition comprising about 1 to 50 weight percent organic acid; about 1 to 50 weight percent inorganic metal oxide; and 0 to 5 weight percent plasticizer.

13. A surface restoration composition as in claim 12 further comprising a dispersant.

14. A surface restoration composition as in claim 12 further comprising a thickener.

15. A surface restoration composition as in claim 12 further comprising water.

16. A surface restoration composition comprising an organic acid; inorganic metal oxide particles; and plasticizer, wherein said composition restores a stone surface to a high gloss finish in a non-abrasive manner.

17. A surface restoration composition as in claim 16 comprising about 1 to 50 weight percent organic acid; about 1 to 50 weight percent inorganic metal oxide; and 0 to 5 weight percent plasticizer.

18. A method of restoring a stone surface comprising applying a composition to the surface and buffing the composition to dryness to achieve a desired level of gloss on the stone surface.

19. A method of restoring a stone surface as in claim 18 wherein said composition includes an organic acid, a metal oxide, and a plasticizer.

20. A method of restoring a stone surface as in claim 19 wherein said composition includes about 1 to 50 weight percent organic acid; about 1 to 50 weight percent inorganic metal oxide; and 0 to 5 weight percent plasticizer.
